(19) United States
(12) Patent Application Publication
(10) Pub. No.: US 2004/0159350 A1
(43) Pub. Date: Aug. 19, 2004

(54) Inflation valve for an inflatable article

(76) Inventor: I-Chuan Lai, Taichung Hsien (TW)

Correspondence Address: TROP, PRUNER & HU P.C., Suite 100, 8554 Katy Freeway, Houston, TX, 77024, US

(21) Appl. No.: 10/365,903

(22) Filed: Feb. 13, 2003

(51) Int. Cl. F16K 15/20

(52) U.S. Cl. 137/223

(57) ABSTRACT

An inflation valve includes a valve body having a head portion and an extended portion extending integrally from the head portion, and a needle holder disposed within the valve body. The extended portion has a central passage with a length that is sufficient to prevent an inflation needle from extending therethrough. The needle holder includes a central inflation hole that is in fluid communication with the central passage and that is adapted to permit extension of the inflation needle therethrough.

### BACKGROUND OF THE INVENTION

1. Field of the Invention

The invention relates to an inflation valve, more particularly to an inflation valve for an inflatable article.

2. Description of the Related Art

Referring to FIG. 1, an inflatable article, such as an inflatable ball 10, is shown to incorporate a conventional inflation valve 14. The inflatable ball 10 has an outer surface layer 11, a fiber layer 12, and an inner bladder layer 13. The inflation valve 14 is disposed at a predetermined position, and includes a valve body 141 connected securely to the inner bladder layer 13, and a needle holder 142 disposed fixedly within the valve body 141. The needle holder 142 includes a central inflation hole 143 that permits insertion of an inflation needle 1 therethrough so as to inflate the ball 10.

Although the conventional inflation valve 14 can achieve its intended purpose, it suffers from the following disadvantages during actual use:

1. Referring to FIG. 2, inflation of the ball 10 is generally done by inserting the entire shank portion of the inflation needle 1 into the inflation valve 14. Since the total length from the outer surface layer 11 of the ball 10 to an innermost end of the valve body 141 is usually shorter than the length of a standard inflation needle 1, the inner bladder layer 13 of the ball 10 may be pricked by the tip 101 of the inflation needle 1 during inflation, thereby damaging the inner bladder layer 13 of the ball 10, and thereby causing the ball 10 to lose its inflatable function.

2. Referring to FIG. 3, in order to reduce possibility of pricking of the inner bladder layer 13 of the ball 10 by the tip 101 of the inflation needle 1, the ball 10 is completely inflated or half-inflated during delivery. However, this method can only increase packing and delivery costs due to the large volume occupied by the inflated or half-inflated ball 10.

### SUMMARY OF THE INVENTION

Therefore, the object of the present invention is to provide an inflation valve that is capable of overcoming the aforementioned drawbacks of the prior art.

According to this invention, an inflation valve is adapted for use with an inflatable article, which has an outer surface layer and an inner bladder layer and which is to be inflated using an inflation needle. The inflation valve comprises a valve body and a needle holder. The valve body includes a head portion adapted to be connected securely to the inner bladder layer, and an extended portion extending integrally from the head portion. The extended portion has a central passage that is adapted for extension of the tip of the inflation needle thereinto and that has a length sufficient to prevent the needle from extending therethrough. The needle holder is disposed within the valve body, and includes a central inflation hole that is in fluid communication with the central passage so as to be adapted to permit extension of the inflation needle therethrough.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of an inflatable ball that incorporates a conventional inflation valve;

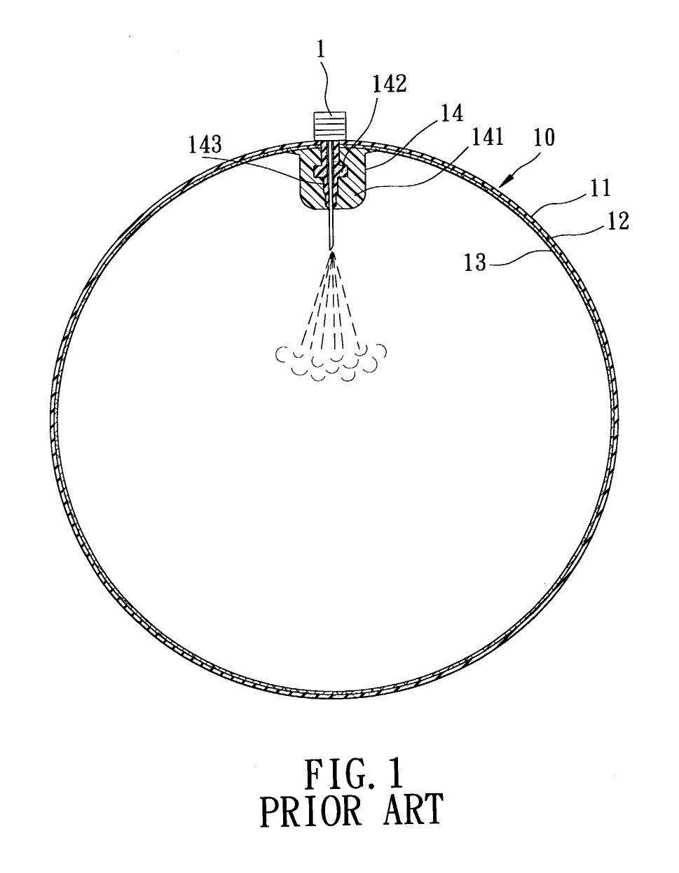

FIG. 2 is a fragmentary sectional view of the inflatable ball shown in FIG. 1, illustrating how an inflation needle can prick an inner bladder layer of the ball during inflation;

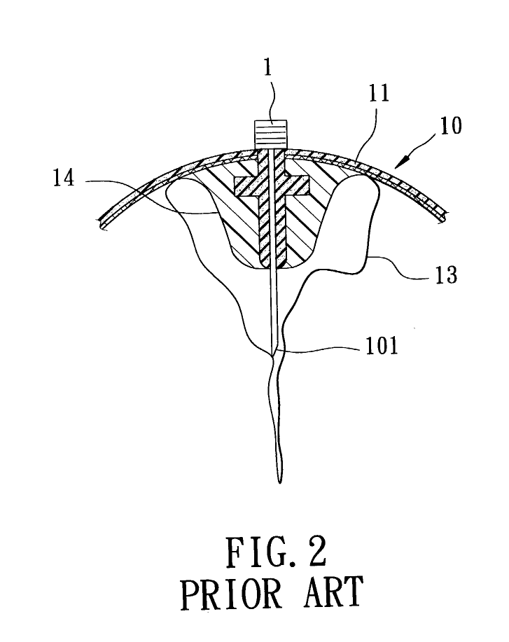

FIG. 3 illustrates the ball of FIG. 1 in a half-inflated state to prevent the inflation needle from pricking the inner bladder layer of the ball;

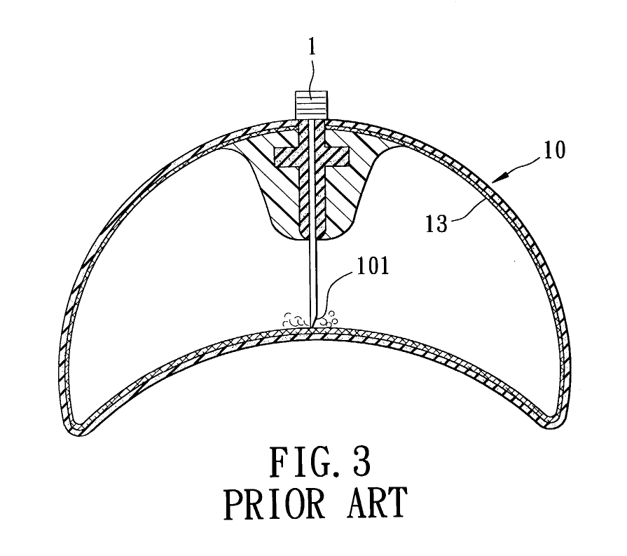

FIG. 4 is a fragmentary sectional view of an inflatable article that incorporates the preferred embodiment of an inflation valve according to the present invention; and

FIG. 5 is a fragmentary sectional view, illustrating how an inflation needle can extend within a passage in a valve body of the preferred embodiment so as to prevent the needle from pricking an inner bladder layer of the ball.

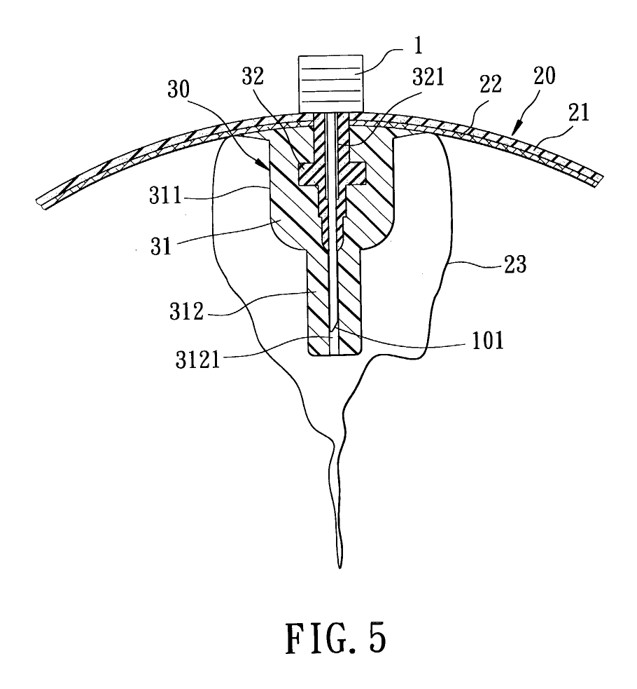

### DETAILED DESCRIPTION OF THE PREFERRED EMBODIMENT

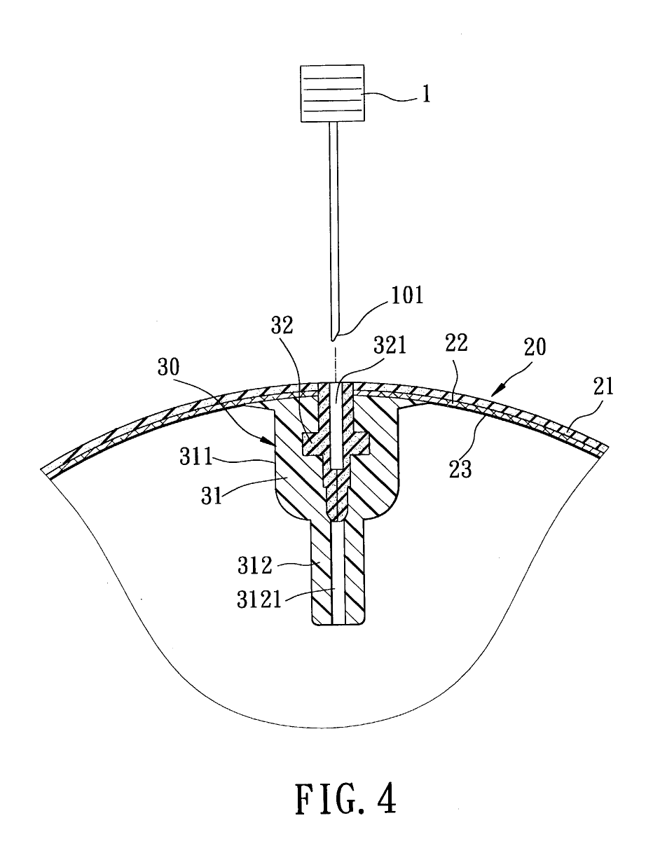

Referring to FIG. 4, the preferred embodiment of an inflation valve 30 according to the present invention is adapted for use with an inflatable article, and is shown to comprise a valve body 31 and a needle holder 32. The inflatable article exemplified in this embodiment is an inflatable ball 20. The inflatable ball 20 has an outer surface layer 21, a fiber layer 22, and an inner bladder layer 23, and is to be inflated using an inflation needle 1.

The valve body 31 includes a head portion 311 having an outer end adhered securely to the inner bladder layer 23 of the inflatable ball 20 in a conventional manner by means of an adhesive, and an extended portion 312 extending integrally and inwardly from an inner end of the head portion 311. The extended portion 312 has a central passage 3121 that is adapted for extension of a tip of the inflation needle 1 thereinto and that has a length such that the total length measured from the outer surface layer 21 of the ball 20 to an innermost end of the extended portion 312 exceeds the length of the needle 1, thereby preventing the needle 1 from extending therethrough.

The needle holder 32 is disposed fixedly within the head portion 311 of the valve body 31, and includes a central inflation hole 321 that is in fluid communication with the central passage 3121 so as to be adapted to permit extension of the inflation needle 1 therethrough. When the needle 1 is inserted into the ball 20 through the inflation hole 321 for inflating the ball 20, the tip 101 of the needle 1 can extend into but not through the passage 3121, thereby preventing the tip 101 of the needle 1 from pricking the inner bladder layer 23 of the ball 20.

From the above description of the preferred embodiment of the inflation valve 30 of the present invention, it is apparent that with the presence of the extended portion 312 on the valve body 31 of the inflation valve 30, the tip 101 of the inflation needle 1 cannot project from the innermost end of the extended portion 312 during inflation of the ball 20. As such, contact of the tip 101 of the needle 1 with the inner bladder layer 23 of the ball 20 is unlikely to occur. Furthermore, in a complete deflated or a half-deflated state of the ball 20, inflation can proceed smoothly with the use of the inflation needle 1 without damaging the inner bladder layer 23 of the ball 20.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An inflation valve for an inflatable article, which has an outer surface layer and an inner bladder layer and which is to be inflated using an inflation needle, said inflation valve comprising:
a valve body including a head portion adapted to be connected securely to the inner bladder layer, and an extended portion extending integrally from said head portion, said extended portion having a central passage that is adapted for extension of the inflation needle thereinto and that has a length sufficient to prevent the needle from extending therethrough; and
a needle holder disposed within said valve body, and including a central inflation hole that is in fluid communication with said central passage so as to be adapted to permit extension of the inflation needle therethrough.

2. The inflation valve of claim 1, wherein said extended portion of said valve body has an outer diameter smaller than that of said head portion.
